(19) United States
(12) Patent Application Publication
(10) Pub. No.: US 2010/0103182 A1
(43) Pub. Date: Apr. 29, 2010

(54) ACTIVE MATRIX DISPLAY DEVICE

(76) Inventor: Kazuyoshi Kawabe, Kanagawa (JP)

Correspondence Address: EASTMAN KODAK COMPANY;PATENT LEGAL STAFF, 343 STATE STREET, ROCHESTER, NY, 14650-2201, US

(21) Appl. No.: 12/531,497

(22) PCT Filed: Mar. 12, 2008
(86) PCT No.: PCT/US08/03231

§ 371 Date: Sep. 16, 2009

(30) Foreign Application Priority Data
Mar. 29, 2007 (JP) 2007-086536

(51) Int. Cl. G09G 5/36

(52) U.S. Cl. 345/545; 345/76

(57) ABSTRACT

An active matrix display device (1) having a plurality of pixels arranged in a matrix includes a frame memory (4) storing one frame of image data, a sub-frame timing generator circuit (2) controlling the timing of reading data from the frame memory, and a display portion (7) performing display according to the data output from the frame memory. The sub-frame timing generator circuit (2) is able to generate a plurality of read timing patterns each for displaying a different number of sub-frames per frame, that means each pattern is associated with how many times data is to be displayed in one frame. A mode setting signal determines the number of sub-frames per frame to be used and data is read from the frame memory according to the corresponding read timing pattern.

### FIELD OF THE INVENTION

The present invention relates to a display device in which a pixel is arranged in a matrix form, a self-emissive element and an element which controls light emission of the self-emissive element.

### BACKGROUND OF THE INVENTION

Active matrix display devices are now in widespread use as displays due to their high resolution. Here, an active matrix display device requires, for each pixel, an active element for determining a display state. For a current-driven display, such as an organic EL display, in particular, a driving transistor capable of continuously supplying an electric current to a light emissive element is provided. While a thin film transistor (TFT) formed of a thin film of amorphous silicon, poly-silicon, or the like is commonly used as such a driving transistor, ensuring the uniformity of characteristics of the TFT remains problematic.

Several methods of correcting the TFT characteristics with circuit technology have been proposed, with one such method being that known as digital driving. A method of controlling the gray level of an active matrix organic EL display by means of digital driving is disclosed in WO 2005/116971A1.

With digital driving, however, one frame is divided into a plurality of sub-frame periods, and bit data for controlling whether or not light is to be emitted is written in each sub-frame period. As such, with digital driving, bit data must be written in a pixel a number of times corresponding to the number of sub-frames during one frame period.

Because with digital driving, in which one frame is divided into a plurality of sub-frames and digital data corresponding to each bit data is repeatedly written during one frame period as described above, lines must be charged and discharged more frequently, power consumption is disadvantageously increased.

### SUMMARY OF THE INVENTION

In accordance with one aspect of the present invention, there is provided an active matrix display device including, in each of a plurality of pixels arranged in a matrix form, an element which controls display of the pixel, and further including a frame memory which stores one frame of data for each pixel; a sub-frame timing generator circuit which controls timing of reading data from the frame memory; and a display portion which performs display according to data which is output from the frame memory, wherein, in the sub-frame timing generator circuit, a plurality of patterns of read timings having different numbers of sub-frames per frame associated with how many times data is to be displayed in one frame is provided, and data is read from the frame memory at a read timing concerning the number of sub-frames per frame determined according to a mode setting signal.

With the above aspect is preferable that the number of sub-frames at least for one frame can be one sub-frame for one frame or a plurality of sub-frames for one frame.

Also, it is preferable that a static memory of at least one bit is provided in each pixel of the display portion and, data rewriting is not performed with regard to a pixel corresponding to a region in which change of display is not necessary.

In addition, it is preferable that an organic EL element is provided in each pixel of the display portion.

According to the present invention, with the sub-frame timing generator circuit, timing of reading data from the frame memory can be changed in accordance with the number of sub-frames. Accordingly, the number of times in which data is output to the display portion is reduced when the number of sub-frames is small, so that effective display can be achieved.

### BRIEF DESCRIPTION OF THE DRAWINGS

A preferred embodiment of the present invention will be described in detail based on the following figures, wherein:

FIG. 1 is a view showing correspondence between display modes and sub-frame structures;

FIG. 2 is a view showing the overall structure of an organic EL display and an internal structure of a data driver according to the present invention;

FIG. 3 is a circuit diagram showing a dynamic memory type pixel;

FIG. 4 is a circuit diagram showing a PMOS static memory type pixel;

FIG. 5 is a circuit diagram showing a CMOS static memory type pixel;

FIG. 6 is a circuit diagram showing a PMOS current control static memory type pixel;

FIG. 7 is a view showing the overall structure of an organic EL display;

FIG. 8 is a structural view of a gate driver; and

FIG. 9 is a view for explaining partial update processing.

### DETAILED DESCRIPTION OF THE INVENTION

A preferred embodiment of the present invention will be described in detail with reference to the accompanying drawings.

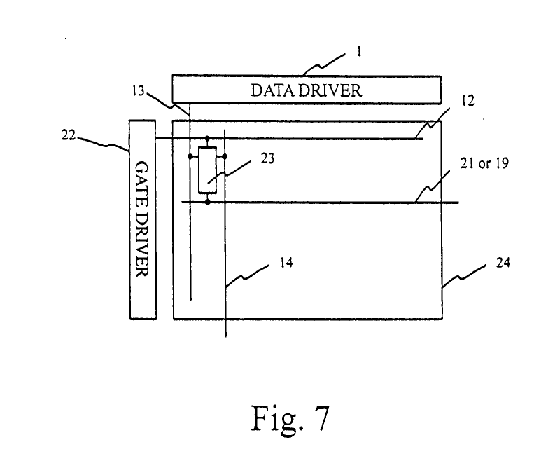

Referring to FIG. 7, an example organic EL display includes a pixel array 24 serving as a display portion in which pixels 23 are arranged in a matrix, a data driver 1, and a gate driver 22. Here, the gate driver 22 and the pixel array 24, which are formed on the same substrate, can be collectively referred to as a display panel.

In order to supply a selection signal and a data signal to each of the pixels 23 arranged in a matrix, a gate line 12 is arranged for each row along the row direction, and a data line 13 is arranged for each column along the column direction. With this structure, a capacitor component is formed where these two lines intersect, and a selection signal and a data signal are appropriately supplied to the pixel 23 by charging and discharging the capacitor. In digital driving, however, in which one frame period is divided into a plurality of sub-frames and data corresponding to each sub-frame is written into a pixel, the rate at which the line capacitor is charged and discharged essentially tends to increase. Consequently, the greater the number of sub-frames, the more power is consumed.

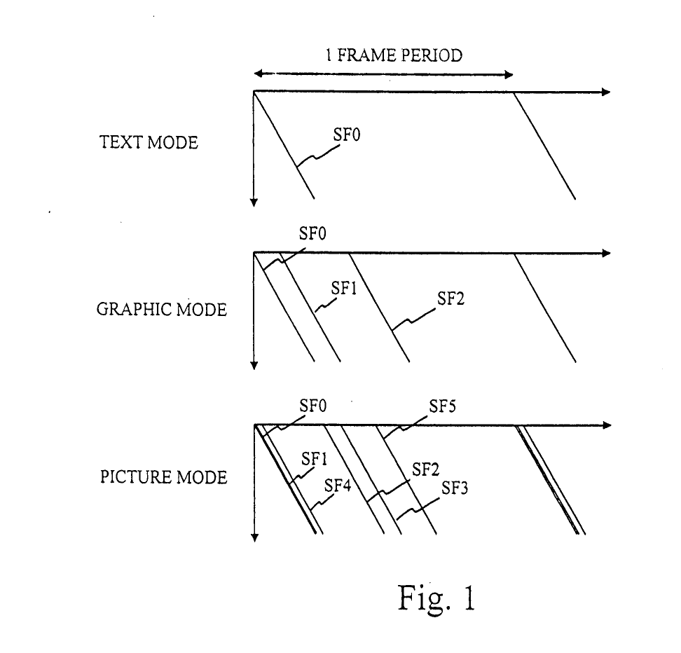

FIG. 1 shows three display modes in accordance with an embodiment of the present invention. In the first display mode which is a text mode, only a sub-frame SF0 is used during one frame period (normally approximately 16.7 ms at 60 Hz), thereby performing 1-bit display. As such, in this text mode, data of SF0 is written into each pixel only once during one frame period. In this display mode, the number of writing is once in one frame period, which clearly indicates that the power consumption is minimized.

In electronic mail applications commonly introduced in mobile terminals or the like, black characters are often displayed against a white background for displaying the content of an electronic message. Because typical users of such mobile terminals use the devices most for viewing and drafting email, active use of such a text mode enables reduced power consumption and operation for an extended time period. Further, by setting the frame period to 60 Hz or less, such as 30 Hz (33.3 ms), as required, the power consumption can be further reduced.

In the second display mode which is a graphic mode, sub-frames SF0 to FS2 are used to perform 3-bit display. In this graphic mode, while the number of sub-frames is increased to thereby increase the power consumption compared with the text mode, multi-level gray display can be achieved. When displaying a standby screen, or any screen which requires simple graphic elements on the mobile terminal, the gray level can be insufficient if the image is displayed in the text mode. Accordingly, with the use of this graphic mode, display with more gray level can be achieved while allowing a certain degree of power consumption.

In the third display mode which is a picture mode, sub-frames SF0 to SF5 are used to perform 6-bit display. In this third display mode, while the number of sub-frames is the largest and the power consumption is the greatest among the first to third display modes, images with the largest number of gray levels can be generated. In the case of displaying more natural images such as when displaying an image captured by a mobile camera, display of 6-bit gray level or more is required. In such a case, a higher priority should be given to the higher gray level over the power consumption, and the image can be positively displayed with multi-value gray levels in the picture mode.

As described above, with digital driving which has characteristic that the greater the gray levels, the more power is consumed, it is possible to reduce the power consumption by using this characteristic flexibly in accordance with the feature of the display content.

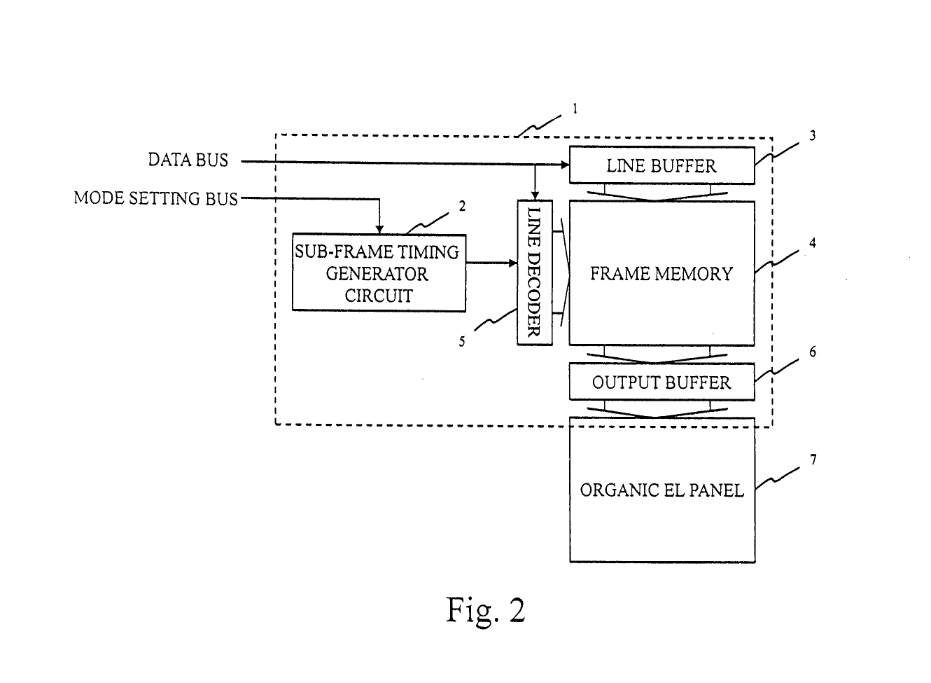

FIG. 2 shows a circuit structure for switching among the display modes shown in FIG. 1. A data driver 1 generates a timing of digital driving based on data input from the data bus and a timing signal, and outputs the timing to an organic EL panel 7. The organic EL panel 7 includes the pixel array 24 having pixels 23 including circuits to be described below arranged in a matrix and the gate driver 22, which are formed on the same substrate. The gate driver 22 is controlled by a signal supplied from the data driver 1, so that selective writing of data of the pixel 23 is appropriately performed.

The data in dot units input from the data bus is first stored in a line buffer 3 in units corresponding to one line. A line decoder 5 selects a line within a frame memory 4 corresponding to the data on the line buffer 3, so that the data on the line buffer 3 is written in the frame memory 4 in units of line. When processing at most 6 bits of data, for example, the data bus is formed of six lines, and data on the data bus is captured into the line buffer 3 in parallel. The frame memory 4 can also store 6 bits of data corresponding to one pixel, and data on the line buffer 3 is stored in corresponding lines of the frame memory 4.

In this manner, once the data for one complete screen is written into the frame memory 4, the line decoder 5, in accordance with the procedure of digital driving disclosed in WO 2005/116971A1, for example, selects a corresponding line from the frame memory 4 for reading the line data. Specifically, in the text mode, the line decoder 5, in accordance with a timing signal and a resulting reference signal which is incremented for each line, reads data for SF0 from each pixel data of the corresponding line in the frame memory 4 once each read timing for each line, while in the picture mode data corresponding to up to three lines must be output from the frame memory 4 at that same timing. Accordingly, the time for selecting one line is divided into three time periods, and data of a different line is read from the corresponding pixel memory of the frame memory 4 at each of the divided time periods, and the data that is read is sequentially output via an output buffer 6. More specifically, for the picture mode, a reference signal specifying the lines is decoded, and a signal which selects up to three lines is output in the divided three time periods. In other words, the line decoder 5 selects one of the modes in accordance with a mode setting signal and decodes the reference signal for the reading the line, thereby generating an address of the reading line necessary in the corresponding mode shown in FIG. 1. Consequently, the line data which is read from the frame memory 4 is output to the organic EL panel 7 via the output buffer 6. Here, it is preferable that two-level latches are provided, and the read data which is temporarily latched is transferred to the latch at the subsequent level at the next timing for outputting to the organic EL panel 7.

Here, the frame memory 4 can be configured to store data of three display modes separately in each pixel. In the case of data of the three display modes described above, for example, a data amount to be stored in the frame memory 4 corresponding to one pixel can be set to 1+3+6=10 bits, so that data corresponding to any one of the display modes can be read based on the mode setting signal. Alternatively, a data amount to be stored in one pixel can be set to only 6 bits, so that data of the corresponding number of bit is read sequentially from the MSB in accordance with the display mode (bit number) of the mode setting signal.

In conventional digital driving, a timing corresponding to the same sub-frame structure is always generated regardless of the nature of the display content. According to the present invention, on the contrary, the introduction of a sub-frame timing generator circuit 2 makes it possible to adjust the timing according to a set display mode.

Specifically, with regard to three different predetermined sub-frame timings corresponding to the first, second, and third modes shown in FIG. 1, i.e. a text mode, a graphic mode, and a picture mode, for example, when one of the three modes is selected by a mode setting signal supplied to the mode setting bus, the sub-frame timing generator circuit 2 controls the line decoder 5 at the corresponding timing. For example, when the text mode is selected, one line of the frame memory 4 is selected only once each frame and the corresponding one bit of data is output via the output buffer 6 to the organic EL panel 7. Similarly, in the graphic mode and the picture mode, 3 bits of data or 6 bits of data are read, respectively, and all data thus read is output to the organic EL panel 7 in accordance with digital driving procedures.

The display modes which are pre-set in the sub-frame timing generator circuit 2 can be further divided into a 2-bit mode and 4-bit mode, for example. Alternatively, the sub-frame timing generator circuit 2 can be further provided with a function of analyzing the display content and automatically switching the display modes. More specifically, because the number of gray levels can be determined in accordance with the content of digital data, the display mode can be determined in accordance with the number of gray levels that is determined. Further, a display mode signal can be externally supplied independently of the display data.

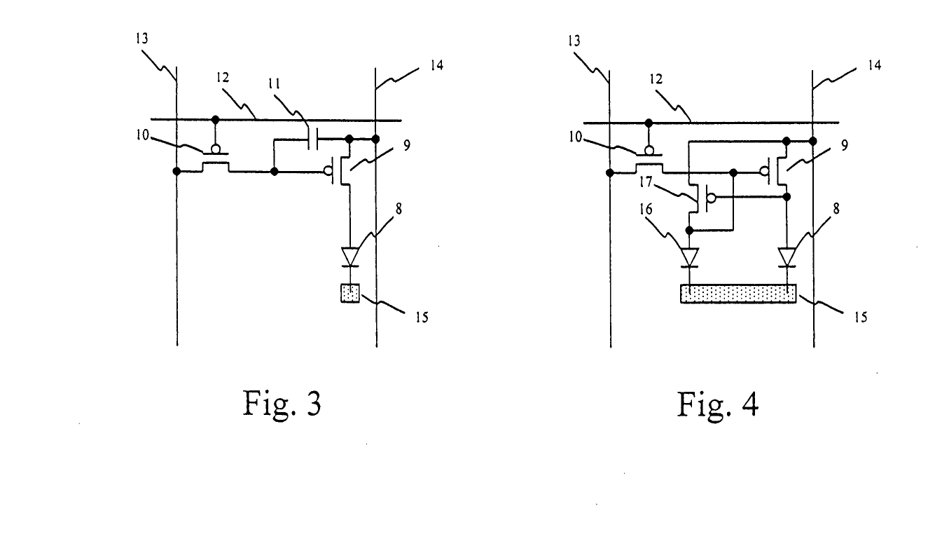

Circuits as shown in FIGS. 3 to 6, for example, can be preferably employed as pixels 23 in an organic EL panel 7.

FIG. 3 shows an example of a dynamic memory type pixel which uses a storage capacitor 11. A gate terminal of a P-type selection transistor 10 is connected with a gate line 12. A drain (or source) terminal of the selection transistor 10 is connected with a data line 13, and a source (or drain) of the selection transistor 10 is connected with a gate terminal of a p-type drive transistor 9 and is also connected with a power source line 14 of a power source voltage VDD via the storage capacitor 11. A source terminal of the p-type drive transistor 9 is connected with the power source line 14 and a drain terminal of the p-type drive transistor 9 is connected with an anode of an organic EL element 8. Further, a cathode of the organic EL element 8 is connected with a cathode electrode 15 which is connected with a cathode power source VSS.

When the gate line 12 is set to a level Low, the selection transistor 10 is turned ON and data supplied to the data line 13 is written into the storage capacitor 11. The data written into the storage capacitor 11 is held even after the selection transistor 10 becomes OFF. Then, an electric current in accordance with the data written in the storage capacitor 11 flows in the organic EL element 8 via the drive transistor 9, and the organic EL element 8 emits light in accordance with the data. This light emission is maintained until data is again written into the storage capacitor 11. However, because the data stored in the storage capacitor 11 is lost when the storage capacitor 11 discharges, the same data must be repeatedly rewritten in order to maintain the same data for a long period of time.

FIG. 4 shows an example of a static memory type pixel formed only of P-type transistors, in which a second organic EL element 16 and a second drive transistor 17 are connected in series to form an inverter for storing data. More specifically, in this pixel, the storage capacitor shown in FIG. 3 is not provided, and a source terminal of the second drive transistor 17 is connected with the power source line 14, and a drain terminal of the second drive transistor 17 is connected with an anode of the second organic EL element 16. A cathode of the second organic EL element 16 is connected with the cathode electrode 15. Further, a connection node of the first drive transistor (the drive transistor) 9 and the anode of the first organic EL element (the organic EL element) 8 is connected with a gate terminal of the second drive transistor 17, and a connection node of the second drive transistor 17 and the anode of the second organic EL element 16 is connected with the gate terminal of the first drive transistor 9.

When the gate line 12 is set to a level Low, the selection transistor 10 is turned ON and data supplied to the data line 13 is supplied to the gate terminal of the first drive transistor 9. If the data is at level Low, the first drive transistor 9 is turned ON, and a power source voltage VDD is applied to the first organic EL element 8, which then emits light. Also, a voltage at the gate terminal of the second drive transistor 17 becomes substantially VDD and the second drive transistor 17 is turned OFF. A voltage at the anode of the second organic EL element 16 becomes substantially VSS, and the ON state of the first drive transistor 9 is maintained. If the data on the data line 13 is at a level High, on the other hand, the first drive transistor 9 is turned OFF and the second drive transistor 17 is turned ON, and this state is stored.

Accordingly, even after the selection transistor 10 is turned OFF, data stored in the static memory formed by the first drive transistor 9 and the second drive transistor 17 is held, and an electric current flows only in one of the first and second organic EL elements 8 and 16. In this example, the first organic

EL element 8 has a relatively large area and light emission thereof contributes to display, whereas the second organic EL element 16 has a relatively small area and does not contribute to display by being shielded from light or emitting no light. The pixel is controlled to emit light when the data on the data line 13 is at level Low.

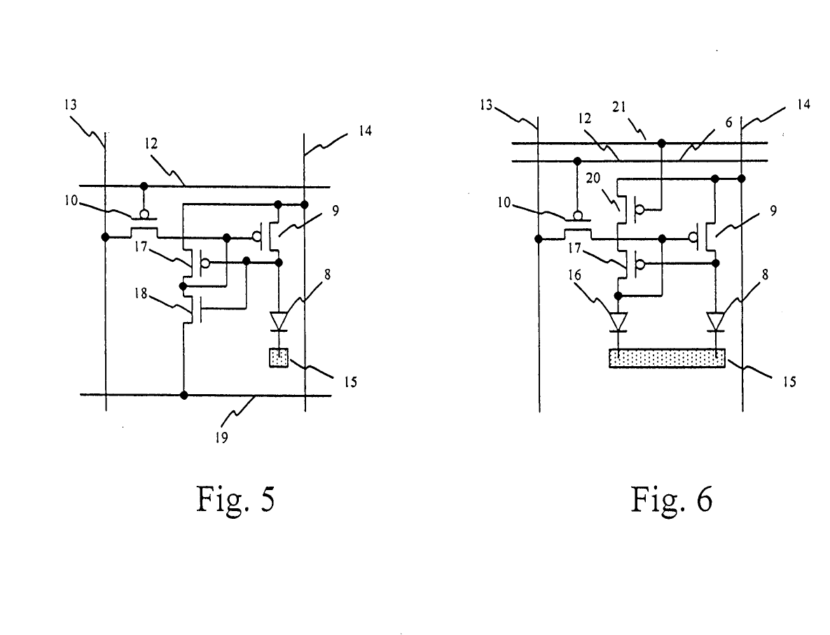

FIG. 5 shows an example of a CMOS static memory type pixel in which an N type transistor 18 is introduced to thereby reduce the power consumption at the time of storing data. More specifically, when compared to the example shown in FIG. 4, the N type transistor 18 is provided in place of the second organic EL element 17. A drain terminal of the transistor 18 is connected with the drain terminal of the second drive transistor 17 and a source terminal of the transistor 18 is connected with a second power source line 19. A gate terminal of the N type transistor 18, as well as the gate terminal of the second drive transistor 17, is connected with a connection node of the drain of the first drive transistor 9 and the anode of the first organic EL element 8. Accordingly, when the second drive transistor 17 is turned ON, the transistor 18 is turned OFF to block an electric current generated when data which turns the second drive transistor 17 ON is written into the static memory.

FIG. 6 shows an example of a low power consumption PMOS static memory type pixel in which a p-type current control transistor 20 is connected in series with the second drive transistor 17 and the power source line 14 so as to reduce the power consumption when data is stored. More specifically, in the example shown in FIG. 16, a p-type current control transistor 20 is inserted between the source terminal of the second drive transistor 17 and the power source line 14 in the structure shown in FIG. 14. A source terminal of the p-type current control transistor 20 is connected with the power source line 14 and a drain terminal of the p-type current control transistor 20 is connected with the source terminal of the second drive transistor 17. A gate terminal of the p-type current control transistor 20 is connected with a control line 21.

When data on the data line 13 is at level High, the second drive transistor 17 is turned ON, and an electric current generated at this time is limited by the p-type current control transistor 20 in accordance with a voltage on the control line 21. In this case, if the anode potential of the second organic EL element 16 is too low, the OFF state of the first drive transistor 9 cannot be maintained. Accordingly, in order to maintain the OFF state of the first drive transistor 9, an amount of electric current at the p-type current control transistor 20 is determined such that the anode voltage of the second organic EL element 16 is equal to or greater than a threshold voltage of the first drive transistor 9.

In the static memory type pixels shown in FIGS. 4, 5, and 6, because data already written is stored, the need to periodically rewrite data in the text mode can be eliminated, which in turn makes it possible to reduce power consumption. Although multi-gray level display by sub-frames is required in the graphic mode and the picture mode, because partial multi-gray level display can be achieved in just a portion of the display area, the power consumption can still be reduced compared to the dynamic memory type pixel of FIG. 3 which must always be refreshed.

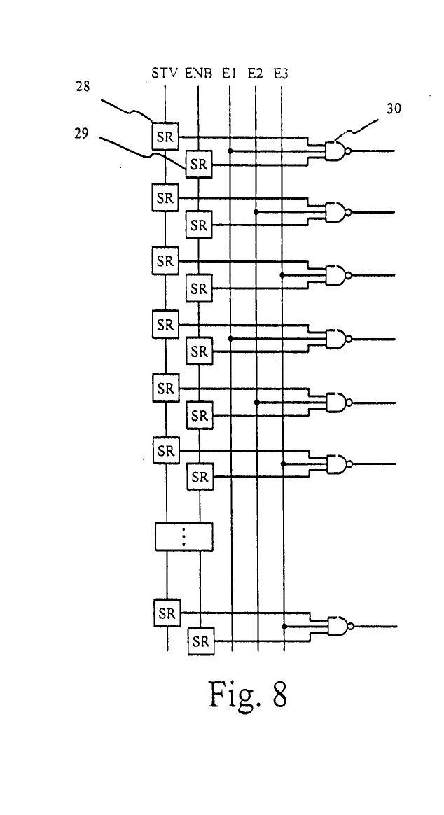

FIG. 8 shows an internal structure of the gate driver 22 which is used for partial rewriting. Referring to FIG. 8, the gate driver 22 includes a selection shift register 28 which shifts selection data to the next line in synchronization with a clock and sequentially selects a gate line, an enable shift register 29 for setting a line which enables an output from the gate driver, and an enable circuit (NAND circuit) 30.

In the gate driver shown in FIG. 8, enable data and a clock (not shown) is first input to an input ENB of the enable shift register 29, to set a line which enables an output of the gate driver. Once setting of all the lines has been completed, no further clock is input to the enable shift register 29. With this processing, with regard to the enable shift registers 29, a line for which “1” is set can be selected based on the data stored in the selection shift register 28, whereas a line for which “0” is set is not selected regardless of the data stored in the selection shift register 28. With this setting, a line to be selected can be limited (set) as desired.

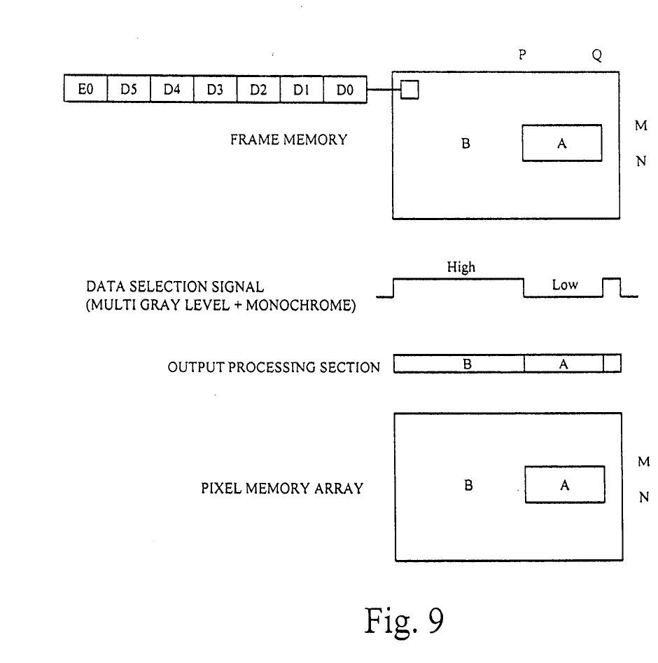

Referring to FIG. 9, a driving method in which the gate driver shown in FIG. 8 is used to perform picture mode display only in a limited area. FIG. 9 shows a frame memory 4 provided in the data driver 1, which can store 7 bits of data corresponding to one pixel, and also shows an example in which an image stored in the organic EL panel 7 capable of storing 1 bit of data per pixel is partially updated.

Of the 7 bit data, E0 bit is used for the text mode (1 bit) display and the other bits D0 to D5 are used at the time of picture mode display. As such, the frame memory 4 is configured to store two types of data simultaneously.

Here, application of a display method in which a region A is designated as a picture mode display region and a region B is designated as a text mode display region will be considered. In this case, because the portion of the display which requires continuous data update can be limited to the region A, the power consumption can be reduced compared to when the entire screen must be updated.

Specifically, first, data is set in the enable shift register 29 to set a line to be enabled, as described above. Here, by setting lines M to N to “1” and setting other lines to “0”, the selection data stored in the selection shift register 28 is applied only to the lines M to N. More specifically, even when selection data for updating the entire screen is applied to the input STV of the selection shift register 28, only the lines M to N are updated.

The region A has a width corresponding to a distance between P and Q. Of the 7-bit memory data described above, data of D0 to D5 is reflected only in this region A, and data of E0 is reflected in the remaining region. With regard to the 7-bit data read from the frame memory 4, which of the data of E0 or data of D0 to D5 is to be output to the output buffer 6 is determined by a data selection signal. Specifically, by setting the data selection signal to level Low only during P to Q, data of D0 to D5 is extracted, and by setting the data selection signal to level High elsewhere, data of E0 is extracted. Then, the extracted data is supplied to the output buffer 6.

Consequently, only in the region of lines M to N in columns P to Q, that is the region A, multi gray level display due to a plurality of sub frames is performed using the data of D0 to D5. In the region other than the lines M to N, “0” data set in the enable shift register 29 is input to one input of the enable circuit 30. Thus, data is processed without charging or discharging the data line 13, and the lines other than the lines M to N are not selected, so that the previous data is continuously displayed without consuming additional power. Further, in the region of lines M to N in columns other than columns P to Q, writing is performed at the same timing as that in the region A, the same data E0 is written again, and consequently the previously-displayed data continues to be displayed without being updated.

Here, the selection data can be input to the selection shift register 28 at the timing for updating the entire screen in digital driving. At this time, only lines for which “1” is set in the enable shift register 29 are reflected in the display. In this case, with regard to the lines other than the lines M to N, data output is performed once for one frame as described above.

As described above, according to the present invention, the enable shift register 29 is provided in the gate driver 22 and the output from the enable shift register 29 is connected to one input of the enable circuit 30, thereby programmably enabling or disenabling the output of the gate driver 22. Consequently, it is possible limit the region in which the graphic mode display or the picture mode display is performed. It should be noted that this structure is similarly applicable to other display modes, including the graphic mode, simply by limiting the reading bit from the frame memory, for example.

Further, a memory function (either static or dynamic) of greater than 1 bit can be provided in the pixel. For example, by providing a pixel memory of 2-bit per pixel and allocating the light emission intensity of 1:2 to the pixel memory of the respective bits, at most 2-bit display (4 gray level display) can be achieved by one frame scanning in the text mode. Such a configuration makes it possible to achieve multi-level gray display while simultaneously reducing power consumption.

### PARTS LIST

1 data driver

2 sub-frame timing generator circuit

3 line buffer

4 frame memory

5 line decoder

6 output buffer

7 organic EL panel

8 organic EL element

9 drive transistor

10 p-type selection transistor

11 storage capacitor

12 gate line

13 data line

14 power source line

15 cathode electrode

16 organic EL element

17 second drive transistor

18 transistor

19 second power source line

20 p-type current control transistor

21 control line

22 gate driver

23 pixels

24 pixel array

28 selection shift register

29 enable shift register

30 enable circuit

1. An active matrix display device having a plurality of pixels arranged in a matrix form, an element, comprising:
a frame memory which stores one frame of data for each pixel;
a sub-frame timing generator circuit which controls timing of reading data from the frame memory;
a display portion which performs display according to data which is output from the frame memory; and wherein:
in the sub-frame timing generator circuit, a plurality of patterns of read timings having different numbers of sub-frames “per frame” associated with how many times data is to be displayed in one frame is provided, and data is read from the frame memory at a read timing of the number of sub-frames per frame determined according to a mode setting signal.

2. The active matrix display device according to claim 1, wherein:
the values for the number of sub-frames per frame include at least one sub-frame per frame and a plurality of sub-frames per frame.

3. The active matrix display device according to claim 1, wherein:
a static memory of at least one bit is provided in each pixel of the display portion, and data rewriting is not performed with regard to a pixel corresponding to a region in which the displayed image does not change.

4. The active matrix display device according to claim 1, wherein:
an organic EL element is provided in each pixel of the display portion.
